(19) United States
(12) Patent Application Publication
(10) Pub. No.: US 2026/0328357 A1
(43) Pub. Date: Oct. 22, 2026

(54) VEHICLE LAMP UNIT

(71) Applicant: KOITO MANUFACTURING CO., LTD., Tokyo (JP)

(72) Inventors: Shuhei NOZUE, Shizuoka (JP); Shingo KURODA, Shizuoka (JP)

(73) Assignee: KOITO MANUFACTURING CO., LTD., Tokyo (JP)

(21) Appl. No.: 19/112,156

(22) PCT Filed: Sep. 15, 2023
(86) PCT No.: PCT/JP2023/033732

§ 371 Date: Mar. 14, 2025

(30) Foreign Application Priority Data
Sep. 15, 2022 (JP) 2022-147366

(51) Int. Cl. F21S 41/33; F21S 41/143; F21S 41/19; F21S 41/25; F21S 41/39; F21S 45/10; F21S 45/70; F21V 23/00; F21W 102/13

(52) U.S. Cl. CPC F21S 41/33; F21S 41/143; F21S 41/19; F21S 41/25; F21S 41/39; F21S 45/10; F21S 45/70; F21V 23/005; F21S 41/141; F21S 41/147; F21S 41/151; F21S 41/153; F21S 41/36; F21S 41/365; F21S 41/40; F21V 7/0083; F21V 11/02; F21W 2102/13

(57) ABSTRACT

A vehicle lamp unit, includes: a first light source; a second light source disposed adjacent to the first light source; a reflector having a first reflecting surface that reflects part of light emitted from the first light source toward the front of a lamp, a second reflecting surface that reflects part of light emitted from the second light source toward the front of the lamp, and a main back surface that faces an emission surface of the first light source and an emission surface of the second light source; and a metal plate having a main blocking portion that blocks the light directed from the first light source toward the main back surface and the light directed from the second light source toward the main back surface.

### TECHNICAL FIELD

The present invention relates to a vehicle lamp unit.

### BACKGROUND ART

In the related art, a vehicle lamp is known in which a plurality of LEDs that form a low-beam light distribution pattern and a high-beam light distribution pattern are mounted in an array on a circuit board. For example, there has been devised a vehicle lamp including a circuit board on which light-emitting surfaces of a plurality of LEDs disposed in two rows, one above the other, are mounted so as to face the front of the vehicle lamp, a reflector that is disposed in front of the circuit board and reflects part of light emitted from the LEDs to form a low-beam light distribution pattern or a high-beam light distribution pattern, and a projection lens that projects the light emitted from the LEDs toward the front of the lamp (Patent Literature 1).

In the vehicle lamp, the plurality of LEDs disposed in a left-right direction on the upper row of the two rows mainly emit light that forms the low-beam light distribution pattern, and the plurality of LEDs disposed in the left-right direction on the lower row mainly emit light that forms the high-beam light distribution pattern. The reflector is made of a metal material such as aluminum having high thermal conductivity.

### CITATION LIST

### Patent Literature

Patent Literature 1: WO2022/009683A1

### SUMMARY OF INVENTION

### Technical Problem

However, since the entire reflector provided in the vehicle lamp described above is a component made of metal, the weight of components tends to increase and material costs also tends to increase. Therefore, although weight reduction and cost reduction can be achieved by forming the reflector with a resin material, the reflector is more susceptible to the heat from a light source than a reflector made of metal.

The present disclosure has been made in view of these circumstances, and an exemplary object of the present disclosure is to provide a new technique for reducing the effects of the heat from a light source.

### Solution to Problem

In order to solve the above problems, a vehicle lamp unit according to one aspect of the present disclosure includes: a first light source; a second light source disposed adjacent to the first light source; a reflector having a first reflecting surface that reflects part of light emitted from the first light source toward the front of a lamp, a second reflecting surface that reflects part of light emitted from the second light source toward the front of the lamp, and a main back surface that faces an emission surface of the first light source and an emission surface of the second light source; and a metal plate having a main blocking portion that blocks the light directed from the first light source toward the main back surface and the light directed from the second light source toward the main back surface.

According to this aspect, since the light directed from the first light source or the second light source toward the main back surface of the reflector can be blocked by the metal plate, the temperature rise of the reflector can be reduced. Therefore, the reflector can be made of an inexpensive and light material such as a resin, instead of an expensive and heavy material such as a metal material or a ceramic material which is a heat-resistant material.

### Advantageous Effects of Invention

According to the present invention, the effects of the heat from a light source on the reflector can be reduced.

### BRIEF DESCRIPTION OF DRAWINGS

FIG. 1 is a side view showing a schematic configuration of a vehicle lamp according to an embodiment of the present invention.

FIG. 2 is a perspective view of a main part of a vehicle lamp unit according to the present embodiment.

FIG. 3 is an exploded perspective view of the vehicle lamp unit shown in FIG. 2.

FIG. 4 is a schematic diagram of a region between a reflector and a circuit board as viewed from the lamp side.

FIG. 5 is a schematic diagram showing positional relations of a protector with respect to the reflector and light sources.

FIG. 6 is an exploded perspective view for explaining assembling positions of the reflector, the protector and a heat sink.

FIG. 7 is a rear perspective view showing a state in which the protector is assembled to the reflector.

FIG. 8 is a schematic diagram for explaining the positioning of the reflector, the protector, and the heat sink.

### DESCRIPTION OF EMBODIMENTS

Hereinafter, the present disclosure will be described based on a preferred embodiment with reference to the drawings. The same or equivalent components, members, and processes shown in the drawings are denoted by the same reference numerals, and redundant descriptions thereof will be omitted as appropriate. The embodiment is illustrative rather than limiting the invention, and not all features and combinations thereof described in the embodiment are necessarily essential to the invention.

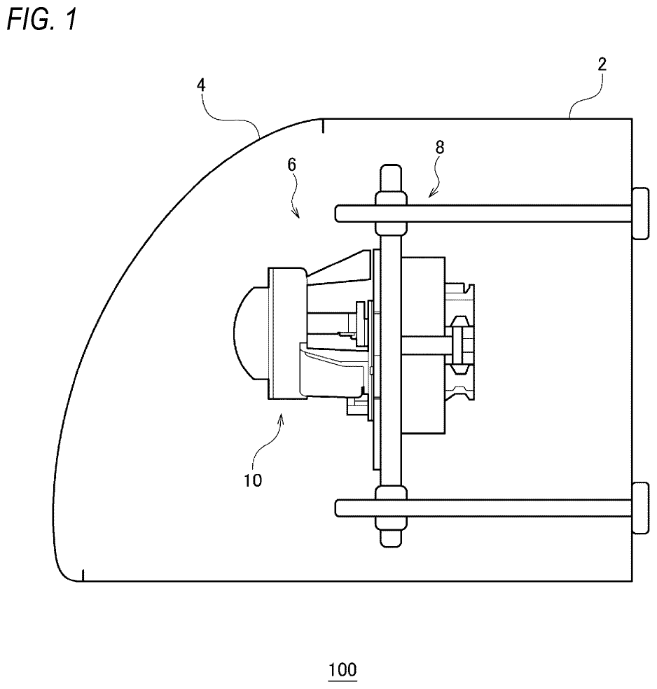

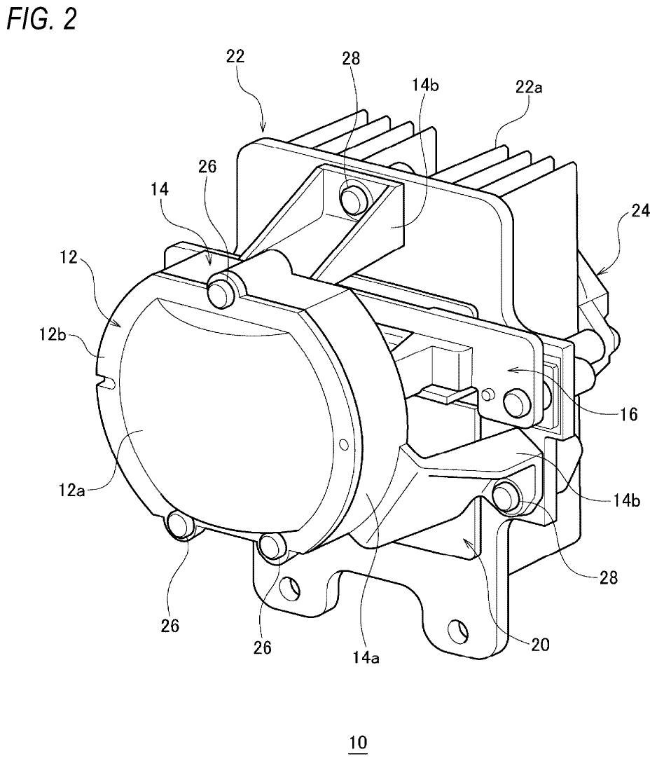

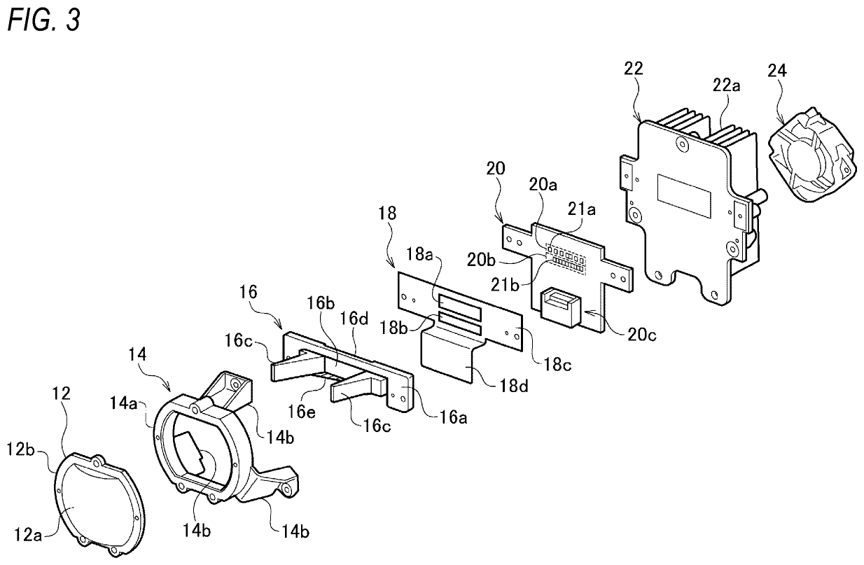

FIG. 1 is a side view showing a schematic configuration of a vehicle lamp according to an embodiment of the present invention. FIG. 2 is a perspective view of a main part of a vehicle lamp unit according to the present embodiment. FIG. 3 is an exploded perspective view of the vehicle lamp unit shown in FIG. 2. A vehicle lamp unit 10 shown in FIGS. 2 and 3 is a vehicle headlamp provided in a front portion of a vehicle, and can form both a low-beam light distribution pattern and a high-beam light distribution pattern.

A vehicle lamp 100 includes a lamp body 2, an outer lens 4 that covers an opening of the lamp body 2, the vehicle lamp unit 10 provided in a lamp chamber 6 surrounded by the lamp body 2 and the outer lens 4, and an aiming mechanism 8 that holds the vehicle lamp unit 10 such that the vehicle lamp unit 10 can be aimed. The vehicle lamp unit 10 includes a projection lens 12, a lens holder 14, a reflector 16, a protector 18, a circuit board 20, a heat sink 22, and a fan 24.

The lens holder 14 has a substantially cylindrical lens holding portion 14a and three leg portions 14b protruding from the lens holding portion 14a toward the rear of the vehicle. The projection lens 12 is a transparent member in which a lens body portion 12a that controls an optical path of light emitted from a light source and a flange-shaped attachment portion 12b that protrudes outward from an outer periphery of the lens body portion 12a are integrally formed. The projection lens 12 is held by the lens holder 14 by aligning the attachment portion 12b of the projection lens 12 with the lens holding portion 14a of the lens holder 14 and fixing the attachment portion 12b and the lens holding portion 14a with screws 26. The projection lens 12 is manufactured by injection molding using a resin material having high transparency and high heat resistance, such as acrylic or polycarbonate.

The reflector 16 according to the present embodiment is made of a resin material for cost reduction and weight reduction. The reflector 16 has a horizontally elongated base surface portion 16a facing a front-rear direction, side reflecting portions 16c provided so as to protrude forward from both left and right sides of an opening 16b formed at the center of the reflector 16, an upper reflector 16d in which an inner surface of a beam-shaped portion above the opening 16b serves as a reflecting surface, and a shade 16e protruding forward from a lower edge portion of the opening 16b.

The protector 18 is, for example, a component formed by bending a plate-shaped metal material into a predetermined shape, and is disposed between the reflector 16 and the circuit board 20. The protector 18 has a rectangular blocking portion 18c in which two openings 18a and 18b are formed, and a circuit protection portion 18d protruding forward in a crank shape from a lower portion of the blocking portion 18c. The circuit protection portion 18d prevents sunlight, which is incident from the outside and concentrated through the projection lens 12, from being emitted to a drive circuit of a light source, which will be described later.

The circuit board 20 includes a first light source 20a in which a plurality of light-emitting elements 21a for forming a low-beam light distribution pattern are disposed in a horizontal row, a second light source 20b in which a plurality of light-emitting elements 21b for forming a high-beam light distribution pattern are disposed in a horizontal row, and a drive circuit 20c that drives light-emitting elements. The second light source 20b is disposed adjacent to the first light source 20a. The first light source 20a is located on an upper side, and the second light source 20b is located on a lower side. The drive circuit 20c is a combination of a passive element such as a capacitor or a coil, an active element such as a transistor or a diode, an IC chip, a memory, and the like, and is mounted in a region of the circuit board 20 below a region where the light sources 20a and 20b are mounted.

The light emitted from the first light source 20a passes through the opening 18a of the protector 18 and the opening 16b of the reflector 16. At this time, a part of the light is reflected by respective reflecting surfaces of the side reflecting portions 16c, the upper reflector 16d, and the shade 16e, and is emitted toward the projection lens 12 in a distributed state. The projection lens 12 projects the light directly arriving from the first light source 20a and the light distributed by the reflecting surfaces in front of the vehicle in a desired light distribution pattern. Accordingly, on a screen in front of the vehicle, a region below the horizon is mainly illuminated with the light of the low-beam light distribution pattern.

Similarly, the light emitted from the second light source 20b passes through the opening 18b of the protector 18 and below the shade 16e of the reflector 16. At this time, a part of the light is reflected by a reflecting surface on a lower side of the shade 16e, and is emitted toward the projection lens 12 in distributed state. The projection lens 12 projects the light directly arriving from the second light source 20b and the light distributed by the reflecting surfaces in front of the vehicle in a desired light distribution pattern. Accordingly, on the screen in front of the vehicle, a region above the horizon is mainly illuminated with the light of the high-beam light distribution pattern. In this way, the projection lens 12 projects a light distribution pattern in front of a lamp with the light emitted from at least one of the first light source 20a or the second light source 20b.

When the light sources described above are driven, heat is generated from the light sources, components constituting the drive circuit 20c, wiring, and the like. A part of the heat generated from the light sources 20a and 20b and the like is transferred to the heat sink 22, and is dissipated to the outside from each part of the heat sink 22, particularly from fins 22a. At this time, cooling air generated by the rotation of the cooling fan 24 flows along the fins 22a, thereby improving heat dissipation. The lens holder 14 is fixed to the heat sink 22 with screws 28.

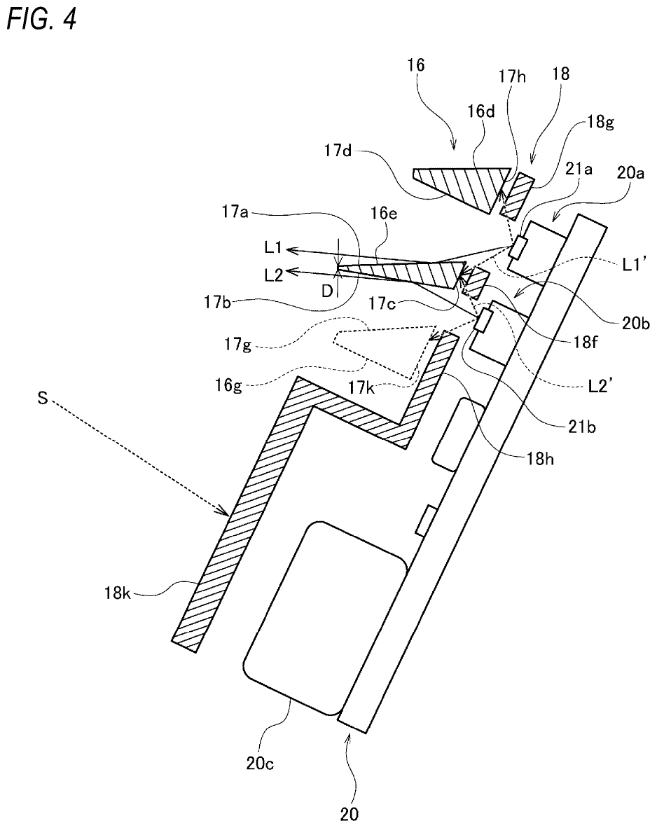

Next, positional relations between the reflector 16 and the light sources will be described. FIG. 4 is a schematic diagram of a region between a reflector and a circuit board as viewed from the lamp side. As shown in FIG. 4, in the vehicle lamp unit 10 according to the present embodiment, the reflector 16 and the light sources 20a and 20b are very close to each other. In particular, the shade 16e, which is a part of the reflector 16, is close to both emission surfaces (light-emitting surfaces) of the upper light-emitting elements 21a and emission surfaces (light-emitting surfaces) of the lower light-emitting elements 21b.

The shade 16e has a first reflecting surface 17a that reflects part of light L1 emitted from the first light source 20a toward the front of the lamp, a second reflecting surface 17b that reflects part of light L2 emitted from the second light source 20b toward the front of the lamp, and a main back surface 17c that faces the emission surfaces of the light-emitting elements 21a and the emission surfaces of the light-emitting elements 21b. Therefore, in the present embodiment, the protector 18 having a main blocking portion 18f that blocks light L1′ from the light-emitting elements 21a toward the main back surface 17c of the reflector 16 and light L2′ from the light-emitting elements 21b toward the main back surface 17c is disposed between the circuit board 20 and the reflector 16.

Therefore, the protector 18 can block the light directed from the first light source 20a or the second light source 20b toward the main back surface 17c of the reflector 16, and thus the temperature rise of the reflector 16 can be prevented. Therefore, the reflector can be made of an inexpensive and light material such as a resin, instead of an expensive and heavy material such as a metal material or a ceramic material which is a heat-resistant material.

The reflector 16 according to the present embodiment further includes the upper reflector 16d having a third reflecting surface 17d that faces the first reflecting surface 17a and reflects a part of the light emitted from the first light source 20a toward the front of the lamp. Although not shown in the reflector 16 shown in FIGS. 2 and 3, a lower reflector 16g having a fourth reflecting surface 17g that faces the second reflecting surface 17b and reflects a part of the light emitted from the second light source 20b toward the front of the lamp may be further provided.

The upper reflector 16d has an upper back surface 17h facing an emission surface of the first light source 20a. The lower reflector 16g has a lower back surface 17k facing an emission surface of the second light source 20b. The protector 18 has an upper blocking portion 18g that blocks light directed from the first light source 20a toward the upper back surface 17h, and a lower blocking portion 18h that blocks light directed from the second light source 20b toward the lower back surface 17k. Accordingly, since the protector 18 can block the light directed from the first light source 20a toward the upper back surface 17h of the reflector 16 and the light directed from the second light source 20b toward the lower back surface 17k of the reflector 16, the temperature rise of the reflector 16 can be prevented.

The shade 16e forms a cutoff line of the light distribution pattern at tip portions of the first reflecting surface 17a and the second reflecting surface 17b. The shade 16e has a thickness D1 of a tip portion of 0.2 mm or less, and is made of a resin using a liquid crystal polymer. The liquid crystal polymer exhibits good fluidity even when the molded article is thin, and is therefore suitable for manufacturing a component such as the shade 16e according to the present embodiment by injection molding. In this way, by forming the reflector 16 with a resin using a liquid crystal polymer, the reflector 16 having the shade 16e with a thickness of 0.2 mm or less can be molded using a mold, and manufacturing costs of the reflector 16 can be reduced.

The protector 18 according to the present embodiment further includes a circuit protection portion 18k extending downward of the lamp from the lower blocking portion 18h so as to be located between the drive circuit 20c and the projection lens 12.

Accordingly, when sunlight S is incident from the outside through the projection lens 12, the circuit protection portion 18k can prevent damage caused by heat to the drive circuit 20c located in a place inside the lamp where light is likely to be concentrated.

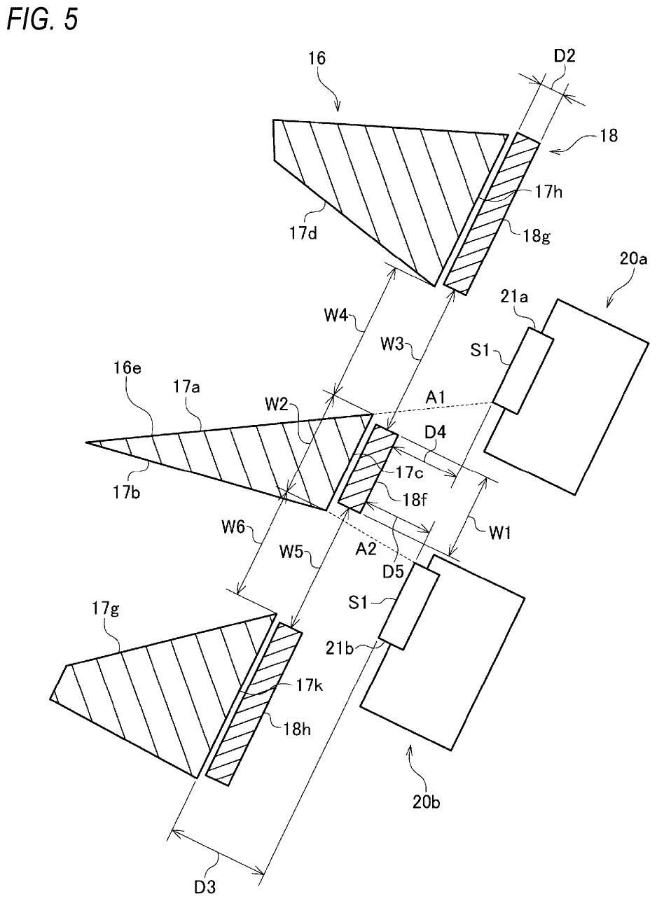

FIG. 5 is a schematic diagram showing positional relations of a protector with respect to the reflector and light sources. In the protector 18 according to the present embodiment, a thickness D2 of a metal plate may be 0.2 mm to 0.6 mm. Accordingly, even when the protector 18 is disposed between the light sources 20a and 20b and the reflector 16, the light sources can be brought closer to the reflector 16. A distance D3 between emission surfaces S1 of the light-emitting elements 21a and 21b and the blocking portions (the main blocking portion 18f, the upper blocking portion 18g, and the lower blocking portion 18h) of the protector 18 may be 0.5 mm to 0.9 mm. In other words, a shortest distance D4 between the emission surface S1 of the light-emitting elements 21a and the main back surface 17c is 0.1 mm to 0.7 mm, and a shortest distance D5 between an emission surface S2 of the light-emitting elements 21b and the main back surface 17c is 0.1 mm to 0.7 mm.

A distance between the back surfaces (the main back surface 17c, the upper back surface 17h, and the lower back surface 17k) of the reflector 16 and the protector 18 is preferably as small as possible, and the back surfaces of the reflector 16 may be in contact with the protector 18. As a result, the proportion of the light that is blocked by the protector 18 in the light emitted from the light sources decreases, and thus the proportion of the light that is actually used for illumination of the lamp in the light emitted from each light sources increases.

The reflector 16 may be fixed to the blocking portions. Here, the fixing includes a case in which the reflector and the blocking portions are integrated together by laser welding or adhesive bonding, and a case in which the reflector and the blocking portions are firmly integrated together by insert molding, in which a metal plate is placed in a mold and a resin that forms the reflector is injected into the mold. Accordingly, since the reflector and the main blocking portions are precisely positioned in advance as one component, the reflector and the protector can be used in assembling the vehicle lamp unit, and thus alignment between the reflector and the protector is not required during assembly.

When the light directed from the light sources toward the first reflecting surface 17a or the second reflecting surface 17b is blocked by the main blocking portion 18f, a desired light distribution pattern may not be formed. Therefore, a width W1 of the main blocking portion 18f of the emitted light is set to be approximately 0.04 mm to 0.08 mm smaller than a width W2 of the main back surface 17c. In addition, the main blocking portion 18f is provided so as not to protrude from a region between two lines A1 and A2 connecting the shortest distance between the emission surfaces S1 of the light sources and the main back surface 17c. Here, the emission surface S1 (S2) is a surface region from which light is actually emitted.

In other words, in the protector 18, an opening width W3 between the main blocking portion 18f and the upper blocking portion 18g is larger than an opening width W4 between the first reflecting surface 17a and the third reflecting surface 17d. In the protector 18, an opening width W5 between the main blocking portion 18f and the lower blocking portion 18h is larger than an opening width W6 between the second reflecting surface 17b and the fourth reflecting surface 17g.

By setting the size of each portion of the protector 18 within the range of the above conditions, the light directed from the light sources toward the first reflecting surface 17a or the second reflecting surface 17b is not blocked by the main blocking portion 18f, and it is possible to prevent occurrence of vignetting to a desired light distribution pattern.

As described above, the positioning accuracy of the protector 18 with respect to the reflector 16 is important.

For example, if the position of the protector 18 with respect to the reflector 16 is deviated from a normal position, a part of the light toward the first reflecting surface 17a or the second reflecting surface 17b may be blocked by the main blocking portion 18f. For example, when the reflector 16 and the protector 18 are positioned with respect to the heat sink 22, the positioning accuracy of the protector 18 with respect to the reflector 16 is affected by both a positioning error of the reflector 16 with respect to the heat sink and a positioning error of the protector 18 with respect to the heat sink.

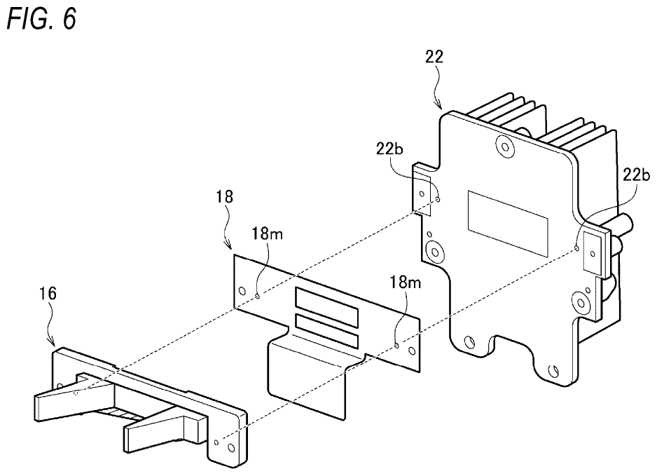

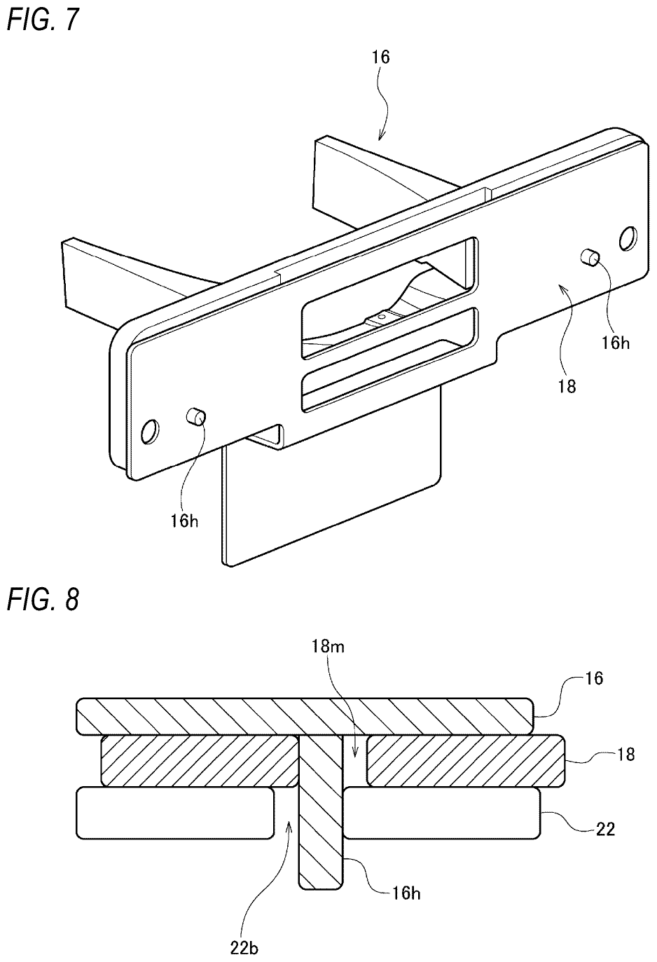

Therefore, the vehicle lamp unit 10 according to the present embodiment employs a configuration in which the protector 18 is positioned with respect to the reflector 16. FIG. 6 is an exploded perspective view for explaining assembling positions of the reflector, the protector and a heat sink. FIG. 7 is a rear perspective view showing a state in which the protector is assembled to the reflector. FIG. 8 is a schematic diagram for explaining the positioning of the reflector, the protector, and the heat sink.

As shown in FIGS. 6 and 7, the reflector 16 is provided with positioning pins 16h protruding from a back surface thereof to a side opposite to the front of a vehicle. The protector 18 is formed with positioning holes 18m into which the positioning pins 16h are inserted. The heat sink 22 is formed with positioning holes 22b into which the positioning pins 16h are inserted. The positioning pins 16h are inserted into the positioning holes 18m and the positioning holes 22b and are fixed with fastening members such as screws. Accordingly, as shown in FIG. 8, since the protector 18 is directly positioned with respect to the reflector 16, the positioning accuracy of the protector 18 with respect to the reflector 16 is improved as compared with a case in which the reflector 16 and the protector 18 are respectively positioned with respect to the heat sink 22.

In the vehicle lamp unit according to the present disclosure, the metal plate may have a thickness of 0.2 mm to 0.6 mm. Accordingly, even when the metal plate is disposed between the light sources and the reflector, the light sources can be brought closer to the reflector in order to increase the utilization efficiency of the light emitted from the light sources.

In the vehicle lamp unit according to the present disclosure, the reflector may further include an upper reflector having a third reflecting surface that faces a first reflecting surface and reflects part of light emitted from a first light source toward the front of lamp, and a lower reflector having a fourth reflecting surface that faces a second reflecting surface and reflects part of light emitted from a second light source toward the front of the lamp. The upper reflector may have an upper back surface facing an emission surface of the first light source. The lower reflector may have a lower back surface facing an emission surface of the second light source. The metal plate may have an upper blocking portion that blocks the light directed from the first light source toward the upper back surface, and a lower blocking portion that blocks the light directed from the second light source toward the lower back surface. Accordingly, since the metal plate can block the light directed from the first light source toward the upper back surface of the reflector and the light directed from the second light source toward the lower back surface of the reflector, the temperature rise of the reflector can be prevented.

In the vehicle lamp unit according to the present disclosure, the reflector may have a shade portion that forms a cutoff line of a light distribution pattern at tip portions of the first reflecting surface and the second reflecting surface. The shade portion is a resin made of a liquid crystal polymer, and may have a thickness of 0.2 mm or less. By forming the reflector with a resin made of a liquid crystal polymer, the reflector having a shade with a thickness of 0.2 mm or less can be formed by molding, and manufacturing costs of the reflector can be reduced.

The vehicle lamp unit according to the present disclosure may further include a projection lens for projecting a light distribution pattern in front of the lamp with the light emitted from at least one of the first light source or the second light source, and a circuit board on which the first light source and the second light source are mounted. The circuit board may have a drive circuit for driving the first light source and the second light source mounted below the first light source and the second light source, and the metal plate may further include a circuit protection portion extending downward of the lamp from the lower blocking portion so as to be located between the drive circuit and the projection lens. Accordingly, when sunlight is incident from the outside through the projection lens, the circuit protection portion can prevent damage caused by heat to the drive circuit located in a place inside the lamp where light is likely to be concentrated.

In the vehicle lamp unit according to the present disclosure, the reflector may be fixed to the main blocking portion. Here, the fixing includes a case in which the reflector and the blocking portions are integrated together by laser welding or adhesive bonding, and a case in which the reflector and the blocking portions are firmly integrated together by insert molding, in which a metal plate is placed in a mold and a resin that forms the reflector is injected into the mold. Accordingly, the reflector and the main blocking portions are precisely positioned in advance as one component, and can be used in assembling the vehicle lamp unit.

In the vehicle lamp unit according to the present disclosure, the reflector may be provided with a positioning pin protruding from a back surface thereof to a side opposite to the front of a vehicle. The metal plate may be formed with positioning hole into which the positioning pin is inserted. Accordingly, the metal plate is directly positioned with respect to the reflector.

Any combination of the above components, and a conversion of the expressions of the present disclosure into a manufacturing method, a device such as a lamp or lighting device, a light-emitting module, a light source, and the like are also valid aspects of the present disclosure.

Although the present invention has been described with reference to the above embodiment, the present invention is not limited to the above embodiment, and appropriate combinations and replacements of the configurations of the embodiment are also included in the present invention. Based on the knowledge of a person skilled in the art, it is possible to appropriately rearrange the combinations and processing orders in the embodiment, and to make various design changes and other modifications to the embodiment, and embodiments to which such modifications are added are also within the scope of the present invention.

The present application is based on a Japanese patent application No. 2022-147366 filed on Sep. 15, 2022, the contents of which are incorporated herein by reference.

1. A vehicle lamp unit, comprising:
a first light source;
a second light source disposed adjacent to the first light source;
a reflector having a first reflecting surface that reflects part of light emitted from the first light source toward the front of a lamp, a second reflecting surface that reflects part of light emitted from the second light source toward the front of the lamp, and a main back surface that faces an emission surface of the first light source and an emission surface of the second light source; and
a metal plate having a main blocking portion that blocks the light directed from the first light source toward the main back surface and the light directed from the second light source toward the main back surface.

2. The vehicle lamp unit according to claim 1, wherein
the metal plate has a thickness of 0.2 mm to 0.6 mm.

3. The vehicle lamp unit according to claim 1, wherein
the reflector further includes an upper reflector having a third reflecting surface that faces the first reflecting surface and reflects a part of the light emitted from the first light source toward the front of the lamp, and a lower reflector having a fourth reflecting surface that faces the second reflecting surface and reflects a part of the light emitted from the second light source toward the front of the lamp,
the upper reflector has an upper back surface facing the emission surface of the first light source,
the lower reflector has a lower back surface facing the emission surface of the second light source, and
the metal plate has an upper blocking portion that blocks the light directed from the first light source toward the upper back surface, and a lower blocking portion that blocks the light directed from the second light source toward the lower back surface.

4. The vehicle lamp unit according to claim 1, wherein
the reflector has a shade portion that forms a cutoff line of a light distribution pattern at tip portions of the first reflecting surface and the second reflecting surface, and
the shade portion contains a liquid crystal polymer and has a thickness of 0.2 mm or less.

5. The vehicle lamp unit according to claim 3, further comprising:
a projection lens for projecting a light distribution pattern in front of the lamp with the light emitted from at least one of the first light source or the second light source; and
a circuit board on which the first light source and the second light source are mounted, wherein
the circuit board has a drive circuit for driving the first light source and the second light source mounted below the first light source and the second light source, and
the metal plate further includes a circuit protection portion extending downward of the lamp from the lower blocking portion so as to be located between the drive circuit and the projection lens.

6. The vehicle lamp unit according to claim 1, wherein
the reflector is fixed to the main blocking portion.

7. The vehicle lamp unit according to claim 1, wherein
the reflector is provided with a positioning pin protruding from a back surface thereof to a side opposite to the front of a vehicle, and
the metal plate is formed with a positioning hole into which the positioning pin is inserted.
